(19) United States
(12) Patent Application Publication
(10) Pub. No.: US 2005/0226521 A1
(43) Pub. Date: Oct. 13, 2005

(54) Method and apparatus for producing a 3-D model of a semiconductor chip from mosaic images

(75) Inventors: Alexander R. LaChance, Ottawa (CA); Zygo Blaxell, Kanata (CA)

Correspondence Address: OGILVY RENAULT LLP, 1981 MCGILL COLLEGE AVENUE, SUITE 1600, MONTREAL, QC, H3A2Y3, CA

(73) Assignee: Chipworks Inc., Ottawa (CA)

(21) Appl. No.: 10/813,060

(22) Filed: Mar. 31, 2004

(51) Int. Cl. G06K 9/36; G06F 7/60

(52) U.S. Cl. 382/254; 703/2

(57) ABSTRACT

A three-dimensional model of a semiconductor chip is produced from coarsely aligned mosaic images of respective layers of the semiconductor chip using an improved method for aligning the mosaic images, so that minimal operator intervention is required to produce the model. A line detection algorithm is applied to each of the mosaic images to produce a set of line segments identified by x and y coordinates of end points of the line segments with respect to a frame defined by a mosaic image in which each line segment occurs. Virtual reference marks are established using end points of different mosaic images that are vertically aligned to within an uncertainty of the coarse alignment of the mosaic images, and the virtual reference marks are used to compute a mean adjustment of the x and y coordinates of each of the mosaic images to produce a three dimensional coordinate space. The end points are processed within the three dimensional coordinate space to define vias, lines and branch lines of the semiconductor chip, which are used to build the three-dimensional model. Operator intervention is only required to verify putative line segments that are marked as uncertain because of poor agreement with predefined rules. The 3-D model may be annotated and viewed separately from the mosaic images.

### CROSS-REFERENCE TO RELATED APPLICATIONS

This is the first application filed for the present invention.

### MICROFICHE APPENDIX

Not Applicable.

### TECHNICAL FIELD

The invention generally relates to the analysis of integrated circuits, and in particular, to a method and system for producing a 3-D model of metal lines in layers of a semiconductor chip.

### BACKGROUND OF THE INVENTION

The reverse engineering of semiconductor chips is an important enterprise in today's technology market, and can be used for product verification, market intelligence purposes, and identifying infringement of intellectual property rights. Semiconductor chips generally include a polysilicon layer and a plurality of metal layers. It is well known to produce mosaic images of an area of interest on a semiconductor chip by stitching together highly magnified images of small parts of the area of interest on each layer of the chip. The images are acquired using an iterated process that alternates between delayering and imaging of the area of interest.

FIG. 1 is a work-flow diagram showing an overview of an exemplary prior art process by which image mosaics representing respective layers of a semiconductor integrated cirduit (IC) exposed at respective delayering steps. ICs 10 are fabricated on a wafer 12. The wafer 12 has a mono-crystalline silicon substrate which is a natural insulator. Doping the silicon substrate with other chemical elements can change the properties of the silicon, to make the silicon substrate a semi-conductor or a conductor. Such substrate processing is performed as part of a manufacturing process 14 of chip 16. In packaging a chip 16, a die 20 is cut in a step 18 from the wafer 12 and is encapsulated in step 22 to form the chip 16.

The manufacture of integrated circuits typically involves a verification process 24 by which wafers 12, cut dies 20, or portions thereof are inspected, and post-manufacturing analysis is frequently performed by third parties using a micro-imaging system 26 to extract design and layout information. Such IC imaging is therefore useful for competitive analysis, as noted above.

Processes of reverse-engineering 28 are therefore known and have been applied to chips 16. A first step in the reverse-engineering process 28 is decapsulation 30 of the chip 16 to remove the die 20. Die 20 is inspected using a micro-imaging system 26 to extract design and layout information. The micro-imaging system 26 may include high magnification optical microscopes, scanning electron microscopes, field emission electron microscopes, or the like. Design and layout extraction from a die 20 or portion thereof involves a process of deconstruction 32 by which layers formed during the manufacturing process 14 are removed step-by-step.

High magnification tile images 34 of the sample die 20 are acquired between each deconstructive step 32 under the control of a computer workstation 36. The computer workstation 36 controls the micro-imaging system 26 using control signals 38. The computer workstation 36 receives tile image data 40 from the micro-imaging system 26 and saves the tile image data 40 to memory, such as a tile image database 42.

The stored tile images 34 are assembled into image mosaics 44, each image mosaic 44 representing a surface of the die 20 at a deconstructive step 32. Before acquisition of the tile images 34 of the die 20, a sample coordinate space 46 is defined. The sample coordinate space 46 is used to coarsely align the image mosaics 44 with respect to each other, within the limits imposed by the accuracy with which the die can be re-aligned to the micro-imaging system 26 after each deconstruction step 32. The resulting image mosaics 44 that are coarsely aligned to each other via the sample coordinate space 46, is then stored in a mosaic image database 48.

FIG. 2 is a process diagram showing an exemplary prior art progression of steps followed during the manufacture of an IC. The diagram shows a progression of cross-sections through a silicon substrate, representing exemplary steps in manufacturing a component such as a junction. In step 52 of the progression, the silicon substrate is doped using diffusion and/or ion implantation techniques to change its characteristics and in particular to define P-wells, well known in the art. In step 54, the implantation technique is used to form an n-type source and drain. A gate oxide layer is deposited between the source and the drain and a field oxide layer over other areas in step 56. A polysilicon gate layer is deposited in step 58, and in steps 60 and 62 the deposition of two oxide layers is effected. Metal layers for providing connectivity between the gates, sources and drains on the silicon substrate are deposited in step 64. Step 66 illustrates the deposition of a passivation layer, typically used to protect the IC from physical damage and/or contamination with dust particles before it is encapsulated in step 22 (FIG. 1).

FIG. 3 is a process diagram showing an exemplary prior art progression of deconstructive steps used to reverse-engineer a sample IC. Step 70 illustrates a cross-section through a silicon substrate of a die 20 after decapsulation in step 30 (FIG. 1). Steps 72, 74, 76, 78, 80 and 82 illustrate a progressive removal of the deposited material layers, such as the passivation layer, metalization layers, polysilicon layers, base contact layers, the field oxide layer, etc. This results in an exposed silicon substrate (step 82) including the well structures manufactured during steps 52 and 54 (FIG. 2). In order to reveal the well structure, the back surface of the die 20 may also be deconstructed. Steps 84 and 86 show the progressive deconstruction of the back surface of the die 20 to expose the P- and N-wells. In extracting design and layout information both surfaces of the die 20 are preferably micro-imaged, and therefore both represent surfaces-of-interest.

Because the delayering of the semiconductor chip cannot be completed on a stage, which may be an optically or interferometer-controlled stage for example, of an imaging device, a well known procedure involving fiduciary marks is used to realign the semiconductor chip on the stage. Imperfections in the alignment of the mosaic images with respect to each other are inevitable. Within a mosaic image, techniques are known for ensuring that distances are accurately reflected and that stitching of the tile images is accurately done, so each mosaic image conforms to x and y coordinates to a very high level of accuracy, but the inter-mosaic (vertical) alignment of these mosaics tends to be much less accurate.

As is known in the art, inaccuracies in inter-mosaic alignment considerably complicates automated feature extraction. Consequently current automated feature extraction requires substantial operator intervention, contributing significantly to an expense of the process and a time required to complete the process.

For example, United States Patent Application Publication No. 2003/00238242409, to Abt et al. published on May 1, 2003 teaches a method for constructing a 3-D vector representation of a semiconductor chip, to facilitate the automation of feature extraction, including line extraction. After automatic line extraction is performed an operator may view the vector representation of the area of interest of the semiconductor chip in order to refine an alignment of the mosaic images, and to correct any errors that were caused by imaging defects, or imperfect delayerng.

According to Abt et al., alignment is enabled by the operator selecting a via or other inter-layer feature shown on two adjacent layers. This method does not produce an optimal alignment, which is critical to an automated or semi-automated construction of a 3-D model.

Furthermore, those skilled in the art of line tracing are aware that the detection of lines using known techniques produces a large number of lines with no discernment between different types of image objects, and limited ability to identify interrupted lines. As the size and complexity of semiconductor chips increase, there is an increasing need for skilled analysts in spite of current attempts to automate circuit analysis.

There therefore remains a need for a method and apparatus that achieves improved alignment between mosaic images of respective layers of an integrated circuit to facilitate automation of integrated circuit analysis.

### SUMMARY OF THE INVENTION

It is therefore an object of the invention to provide a method and apparatus that achieves improved alignment between mosaic images of respective layers of an integrated circuit to facilitate automation of integrated circuit analysis and creation of a 3-dimensional model of a circuit being analyzed.

In accordance with the invention, a three-dimensional model of a semiconductor chip is produced from coarsely aligned mosaic images of respective layers of the semiconductor chip using an improved method for aligning the mosaic images, so that minimal operator intervention is required to produce the model. A line detection algorithm is applied to each of the mosaic images to produce a set of line segments identified by x and y coordinates of end points of the line segments with respect to a frame defined by a mosaic image in which each line segment occurs. Virtual reference marks are established using end points of different mosaic images that are vertically aligned to within an uncertainty of the coarse alignment of the mosaic images, and the virtual reference marks are used to compute a mean adjustment of the x and y coordinates of each of the mosaic images to produce a three dimensional coordinate space. The end points are processed within the three dimensional coordinate space to define vias, lines and branch lines of the semiconductor chip, which are used to build the three-dimensional model. Operator intervention is only required to verify putative line segments that are marked as uncertain because of poor agreement with predefined rules. The 3-D model may be annotated and viewed separately from the mosaic images.

The invention also provides an article comprising a computer readable modulated carrier signal and means embedded in the carrier signal for executing the method of for producing a 3-dimensional model in accordance with the invention.

The invention further provides an article comprising a computer readable memory storing program instructions and means embedded in the memory for executing the methods in accordance with the invention.

The invention likewise provides an article comprising a computer readable modulated carrier signal for transmitting program instructions for executing the method in accordance with the invention.

### BRIEF DESCRIPTION OF THE DRAWINGS

Further features and advantages of the present invention will become apparent from the following detailed description, taken in combination with the appended drawings, in which:

FIG. 1 is a work flow diagram showing an overview of an exemplary process by which image-mosaics representative of steps in a deconstruction of a semiconductor integrated circuit (IC) are acquired;

FIG. 2 is a process diagram showing an exemplary progression of steps in manufacturing an IC;

FIG. 3 is a process diagram showing an exemplary progression of steps in the deconstruction of an IC;

FIG. 4 is a schematic diagram of a system in accordance with the invention;

FIG. 5 is a flow chart schematically illustrating an overview of the invention;

FIG. 6a schematically illustrates a small portion of two coarsely aligned mosaic images;

FIG. 6b schematically illustrates a binary edge bitmap of the small portion of the two coarsely aligned mosaic images;

FIG. 6c schematically illustrates a thinned line bitmap of the small portion of the two coarsely aligned mosaic images;

FIG. 6d schematically illustrates coincidence in the x-y plane of end points of line segments;

FIG. 6e schematically illustrates a thinned line bitmap of the small portion of the two mosaic images in accurate alignment;

FIG. 6f schematically illustrates connected line segments of a 3-D model of the small portion of the two mosaic images;

FIGS. 7a,b are a flow chart schematically illustrating another embodiment of the invention; and

FIG. 8 schematically illustrates a method for supplementing a 3-D model with annotations, and correcting any errors in an automatically generated 3-D model of an integrated circuit.

It should be noted that throughout the appended drawings, like features are identified by like reference numerals.

### DETAILED DESCRIPTION OF THE PREFERRED EMBODIMENT

The invention provides a method for producing a 3-D model of the connectivity of a semiconductor chip from a plurality of image mosaics corresponding to respective layers of an area of interest on the semiconductor chip.

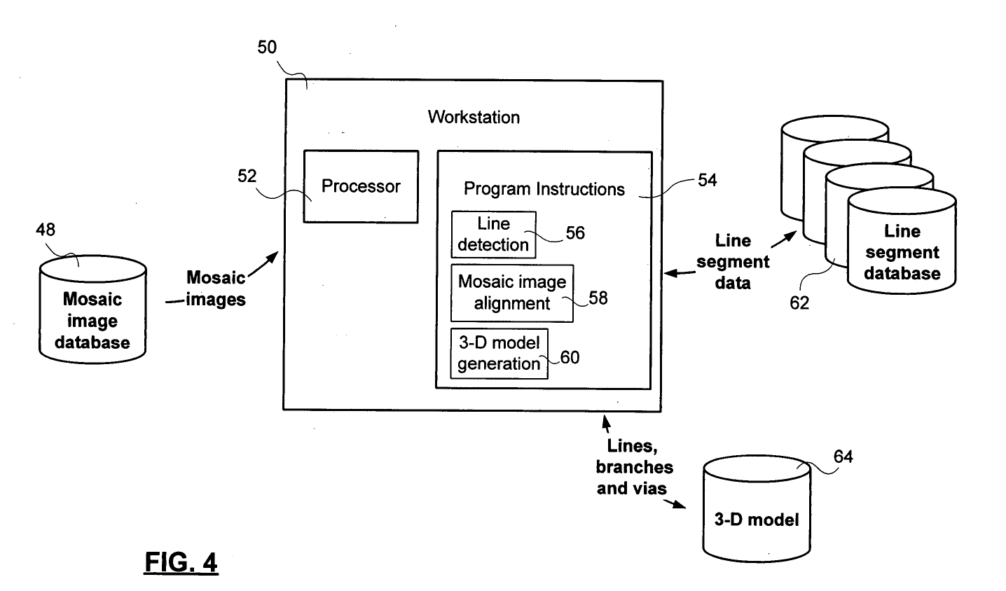

FIG. 4 schematically illustrates an image processing workstation 50 in accordance with an embodiment of the invention. Workstation 50 includes a processor 52 for executing program instructions stored in a memory 54. The memory 54 stores program instructions for carrying out the automated processes of line detection 56, mosaic image alignment 58, and 3-D model generation 60, each of which is further discussed below.

The workstation 50 is adapted to receive the coarsely aligned mosaic image data from the mosaic image database 48, and to apply a line detection algorithm effected using the line detection 56 program instructions. The data output of the line detection algorithm is stored in a corresponding line segment database 62. A plurality of line segment databases may be used, and these may be organized hierarchically according to the layer represented by the mosaic image that is processed, for example.

Records of the line segment database 62 are accessed by the workstation 50 in order to perform mosaic image alignment using the mosaic image alignment 58 program instructions. The line segment data with the fine grain vertical alignment is used by the 3-D model generation 60 program instructions to produce a 3-D model stored in a 3-D model database 64.

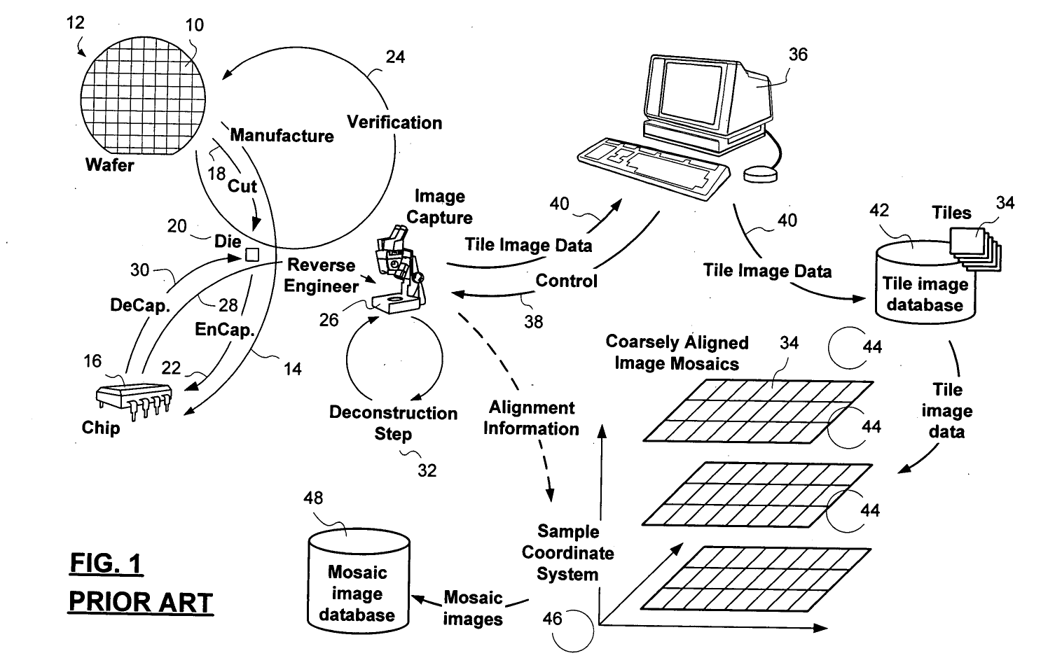

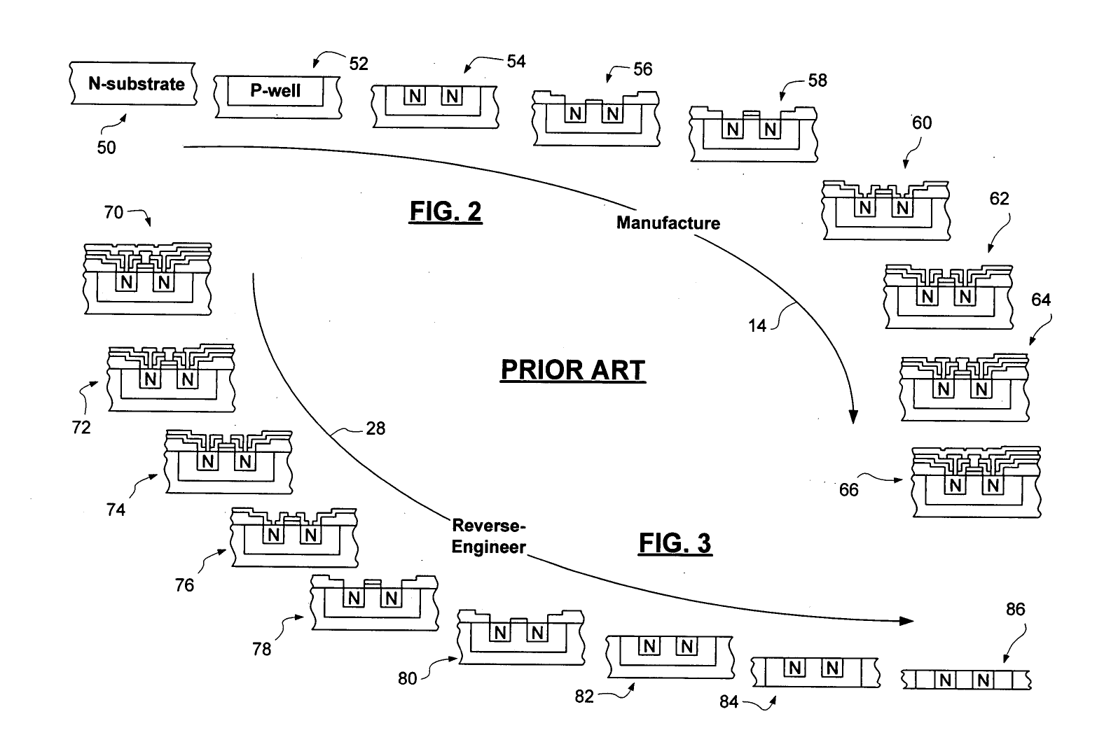

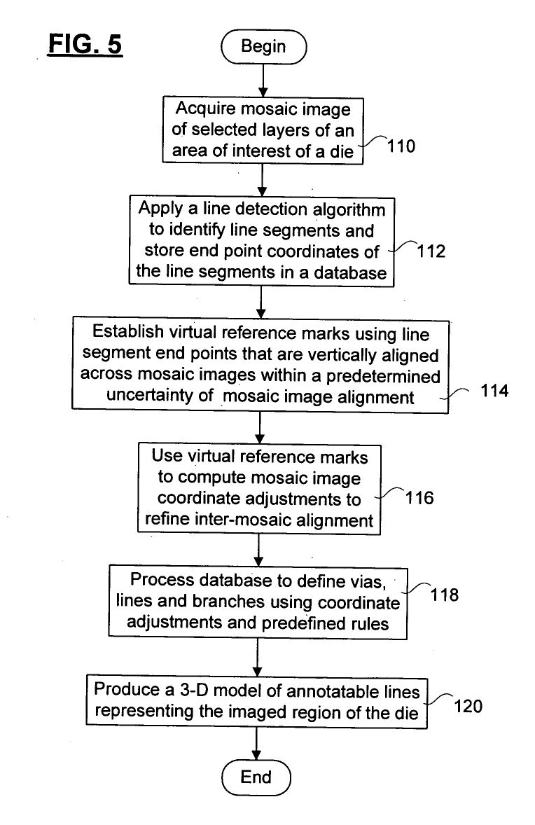

FIG. 5 is a flowchart that provides an overview of a method in accordance with the invention. In step 110, a mosaic image of an area of interest on selected layers of a semiconductor chip (or a die) is acquired, for example in a manner described above with reference to FIGS. 1 and 3. The mosaic images are coarsely aligned using one or more fiduciary marks, for example. In step 112, a line detection algorithm is applied to identify line segments. The line segments are stored as coordinate end points in a database.

After the line segment database has been populated, the coordinates of the end points of different mosaic images are compared to identify sets of end points that are vertically aligned to within a predetermined uncertainty of the coarse mosaic image alignment. The identified sets of end points that are present on the most mosaic images, and that are most closely virtually aligned across the image mosaics are selected to be used as virtual reference marks (step 114) to adjust the inter-mosaic alignment. The identified sets of end points are used to align the mosaics (step 116) in a manner that is considerably more precise than the selection of a single feature for aligning adjacent mosaic images. A mean adjustment computed by statistically minimizing x and y differences in the virtual reference mark end points of the respective mosaic images, permits alignment accuracy up to a fraction of a pixel in dimension.

It should be noted that as used in this document, the phrase “metal lines” (more frequently referred to simply as “lines”) are not geometric lines in the sense that they do not have infinite extent, zero width, and are not continuous in one direction. Rather a metal line, as used in this document, refers to a continuous, electrically conductive path that is generally formed of x direction line segments, y direction line segments, z direction vias between layers, and sometimes, 45 degree (y=+/−x+c) line segments, that are end connected. Branch lines may also extend from a vertex or side of a line.

In step 116, the end points associated with respective mosaic images have all been aligned by computing the mean adjustment of the end points in both x and y directions. The inter-mosaic alignment is also adjusted by the corresponding mean adjustments so that the coordinates of the end points always refer to the same corresponding points on the mosaic images from which they were derived. Once the end points are all defined with respect to an accurate common coordinate space, the positions of the end points are used to identify vias, lines and branches using predefined rules (step 118). The vias, lines and branches defined with the common coordinate space are stored to produce a 3-D model of annotatable lines that represent the area of interest of the die (step 120).

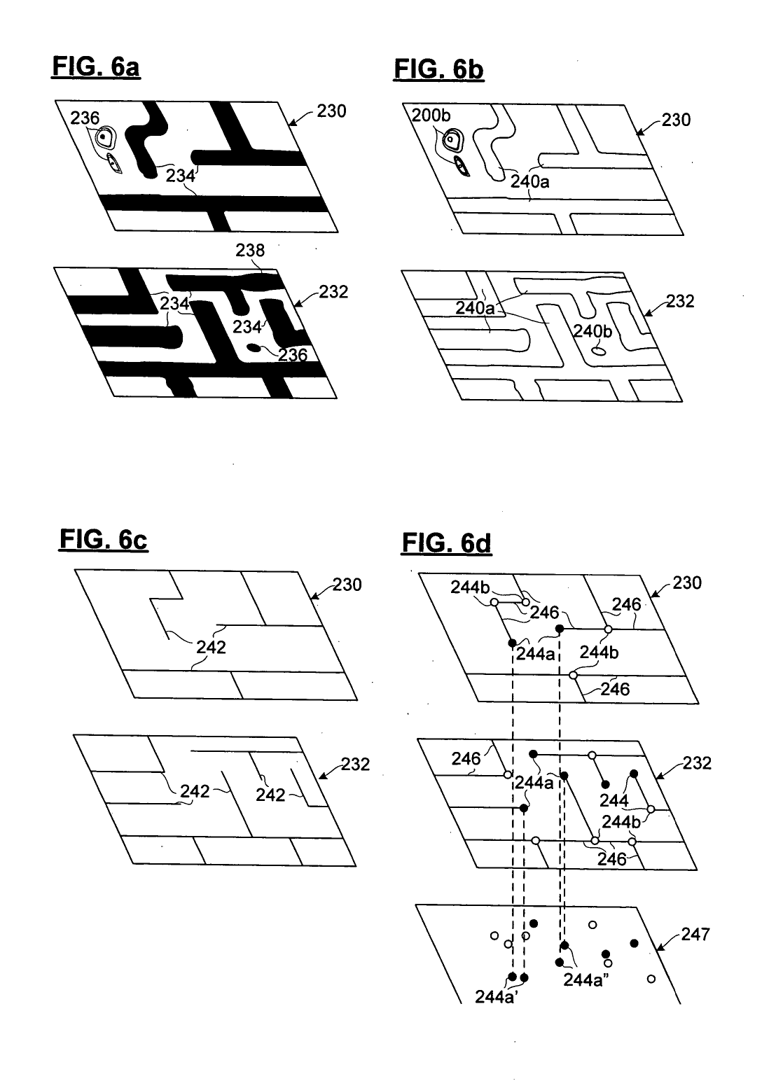

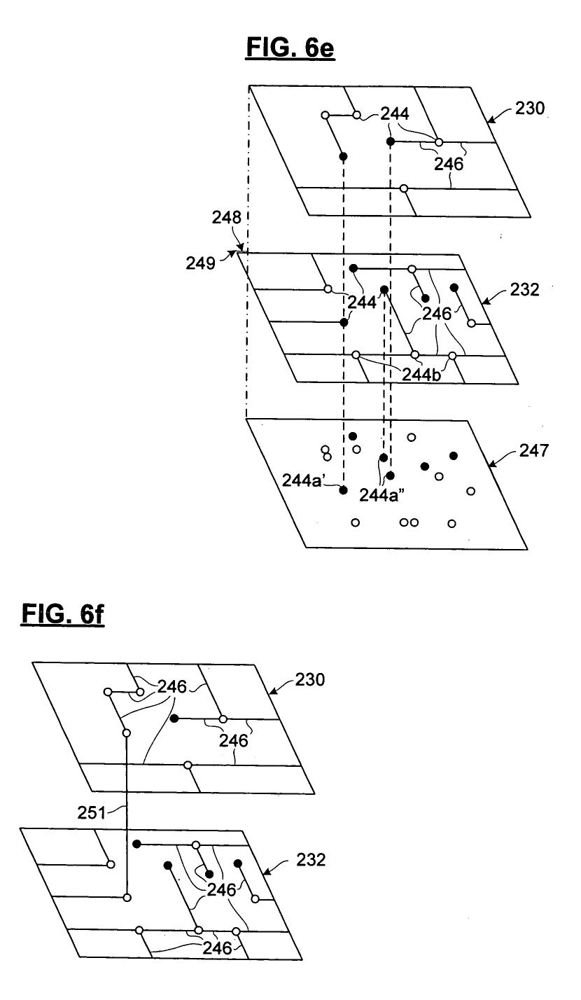

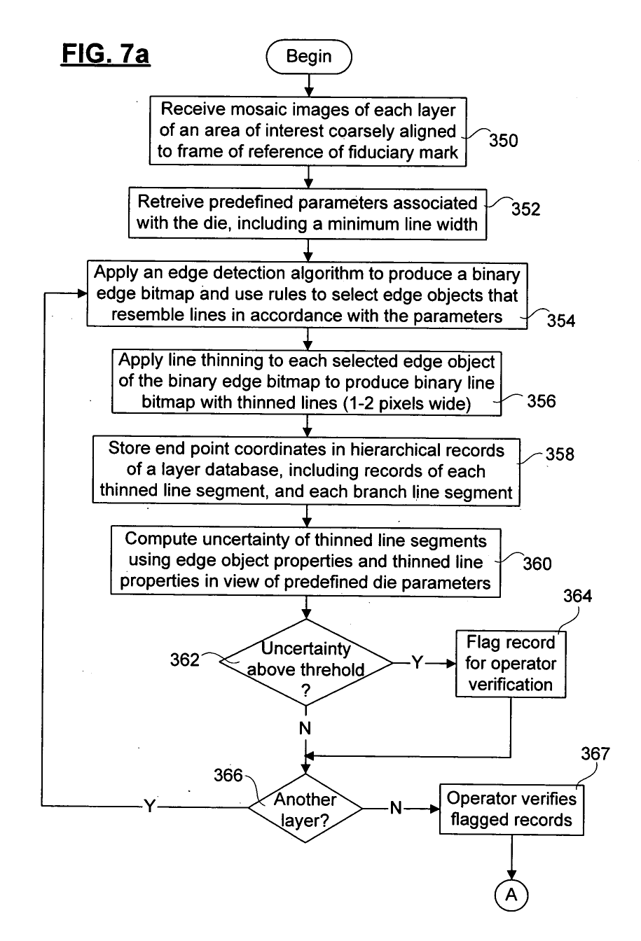

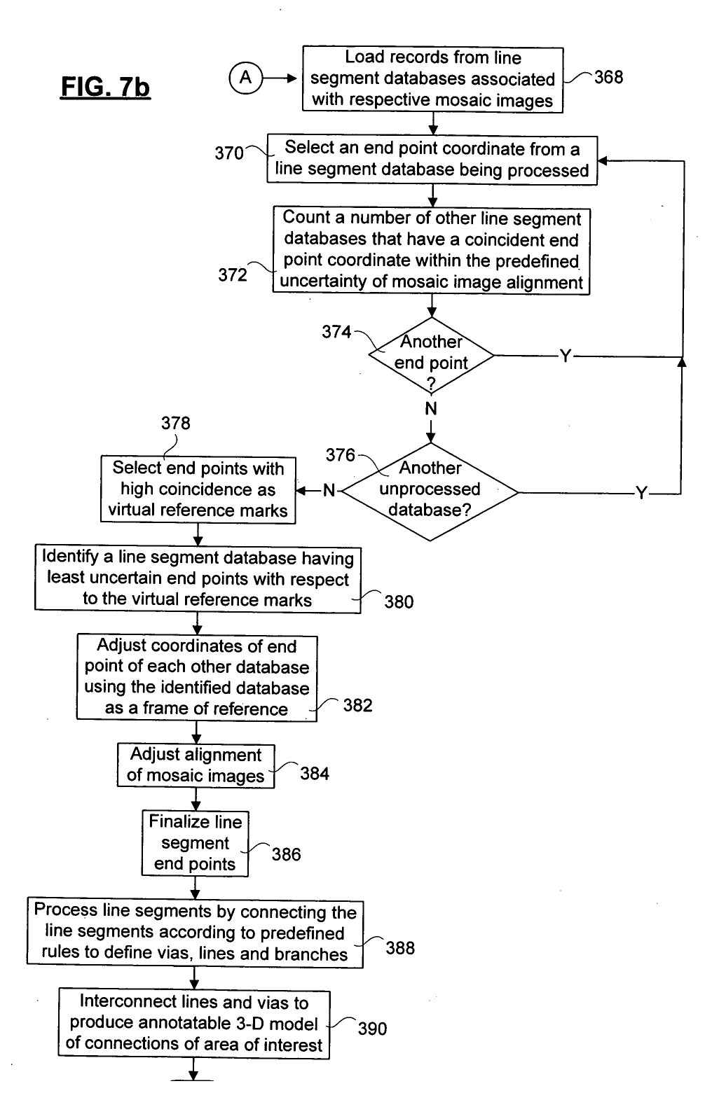

FIGS. 6a-f illustrate respective steps in the method shown in FIGS. 7a,b and are described therewith. FIGS. 7a,b illustrate principal steps in one embodiment of the method in accordance with the invention. In step 350, a set of mosaic images, representing an area of interest of a die, is received. The mosaic images are coarsely aligned with respect to a fiduciary (or like) mark that is present at each layer of the die. The coarse alignment is achieved by aligning the die on the stage using the reference marks, so that coordinates are associated with respective pixels of each mosaic image of the imaged area. FIG. 6a shows a small portion of mosaic images 230, 232 of two adjacent metal layers of a die. Each of the mosaic images 230,232 includes a plurality of lines 234, and imperfections 236 shown in contrast with a background. Furthermore the lines bulge at certain points and are not perfectly straight, as shown at 238.

In step 352, a file containing parameters (observed or otherwise known) about properties of the die is retrieved. The parameters include at least a minimum width of line segments in the die, but may also include such parameters as: a minimum line segment length; a minimum spacing between parallel line segments; a maximum bulge width of a line segment; a maximum or minimum spacing of branch line segments; etc. If these parameters are different at different layers, the parameters may apply only to respective layers. The parameters may be observed during the imaging of the layers, may be deduced from the lithographic (or other) technology used to produce the die, etc. These parameters are useful for line segment detection and for the construction of line segment databases.

In steps 354-360 an exemplary embodiment of a line detection algorithm is applied. In step 354, an edge detector is used to produce a binary edge bitmap from the (digital) mosaic image (or a high-contrast copy thereof). The binary edge bitmap contains white pixels at every location of the mosaic image, except where the corresponding pixel of the mosaic image is bounded on one side by a dark region, and bounded on an opposite side by a light region, in which case the pixel is black. Well known transforms have been successfully applied to produce such binary edge bitmaps using an eight pixel neighborhood of the subject pixel. Such transforms include the following: the Hough transform, Robert's cross transform, the Sobel transform, and the Prewitt transform. Given the overwhelming majority of the line segments sought are either aligned with the x-axis or the y-axis, the Hough transform may be preferred.

FIG. 6b schematically shows a binary edge bitmap of the small parts of the mosaic images shown in FIG. 6a. The binary edge bitmap produces a set of edge objects 240 that correspond to lines 234 (e.g. 240a), or imperfections 236 (e.g. edge objects 240b). An edge object 240 is defined by a polygon formed by adjacent black pixels. The edge objects 240a that are likely to be line segments are distinguished from the other edge objects 240b by comparing dimensions of the polygon with rules associated with the parameters of the die. Generally, edge objects having parts with lengths and widths within predefined ranges (240a) are strongly preferred over edge objects (240b) of other shapes. Each edge object 240 is given an uncertainty measure indicating how well the edge object 240 matches expected edge object parameters. All edge objects 240 having an uncertainty measure below a predefined threshold are selected for line tracing.

In step 356 pixels of the mosaic image within a pixel region of a selected edge object are subjected to a line tracing algorithm. Several line tracing algorithms known in the art can be applied. Currently a line thinning algorithm is preferred, although center-line following techniques may alternatively be used. Line thinning algorithms iteratively whiten a (high contrast) copy of the mosaic image to remove edge pixels, until the line is one or two pixels wide. In accordance with one embodiment, by defining the edge objects as definite pixel regions, the process of line thinning is greatly facilitated. Rather than applying line thinning to all pixels of the mosaic image, only the pixels within the pixel regions delimited by the selected edge objects, are processed. Specific known algorithms for line thinning include: a Zhang Suen skeletonizing algorithm, and a Stentiford skeletonizing algorithm.

The line thinning produces a thinned line binary bitmap, such as those shown schematically in FIG. 6c. The edge objects 240 that were selected are reduced to respective thinned lines 242. Using the thinned line bitmap, coordinates of end points 244a (denoted by solid circles) and vertices 244b (denoted by hollow circles), which are shown in FIG. 6d, are identified so that a table of end points 244 of line segments 246 (i.e. pairs of the end points 244) can be defined (step 358) for each of the mosaic images. It will be noted that labeling of only some of the line segments 246, line end points 244a, vertices 244b and line segment end points 244 is provided for clarity of illustration.

Preferably the end points 244 are stored hierarchically in a line segment database associated with the mosaic image (of a layer of the die) as follows: a record of a first line segment is stored as end points, and at any point along the first line segment from which another line segment extends, the point is noted and a separate record of each of the line segments depending from the first line segment is stored in an associated record. When all of the line segments depending from the first line segment are recorded, all of the line segments depending from one of these line segments is then recorded in a further nested record. The process iterates until all of the line segments of the thinned line bitmap are recorded.

In accordance with a preferred aspect of the illustrated embodiment, each of the line segments is associated with a measure of uncertainty (step 360). For example, a measure of fit between the shape of the edge object, and the expected dimensions of line segments; the smoothness and orientation of the (thinned) line segments; and the precision of the determination of the end points, each contribute to the uncertainty measure associated with a line segment in accordance with the present embodiment. The first use of the uncertainty measure is to determine whether each line segment is so uncertain as to require verification by an operator (step 362). Each line segment with an uncertainty measure that is greater than a predefined threshold is segregated for operator verification (step 364), or flagged in some other way that permits an operator to optionally verify whether the line segment is a valid part of the IC design. The identification of a small fraction of the line segments as ambiguous is efficient and provides a high confidence in the identified line segments for the subsequent automated steps.

Once the records for a first mosaic image are stored in the first line segment database (and flagged if necessary), it is determined whether another mosaic image remains to be analyzed (step 366). If another mosaic image is identified, the mosaic image is retrieved from the mosaic image database, and the process returns to step 354. Otherwise, in step 367, any records that are flagged for operator verification are examined by an operator to determine whether the identified pixel region corresponds to a line segment. The uncertainties of the line segments accepted by the operator are modified and the records of edge objects that do not correspond to line segments are removed from the corresponding line segment database.

In step 368, records of the line segment databases associated with respective mosaic images, are loaded. The coordinates of a selected end point 244 in a currently processed line segment database are identified (step 370), and it is determined how many of the other mosaic images includes an end point vertically above or below the end point coordinates, to within an uncertainty of the coarse alignment of the mosaic images (step 372). In one embodiment the first line segment database processed is associated with a middle layer of the IC. In another embodiment, the first line segment database processed is associated with a mosaic image of a highest metal layer, subsequently lower metal layers are processed in sequence. Vertical alignment of end points to within an uncertainty of the coarse inter-mosaic alignment can be visually represented by measuring proximity of the end points projected onto a common x-y plane. FIG. 6d shows a common x-y plane 247 onto which the end points 244 are projected.

If another end point of the currently processed line segment database has not been processed (step 374), another end point is chosen and the process returns to step 370. Otherwise the “currently” processed line segment database is completely processed, and in step 376, it is determined whether end points of another mosaic image's line segment database remains to be processed. If another line segment database is to be processed, another line segment database becomes “current”, and the method returns to step 370. Otherwise the method advances to step 378. In this manner, the method cycles through the end points of the line segments of all of the line segment databases determining a number of proximate end points in the common x-y plane for each end point.

In step 378, the number of proximate end points per respective end point is compared to identify end points having high coincidence in the x-y plane 247, so that from among these high coincidence end points, a set of virtual reference marks can be selected. Preferably the selection provides for a complete set of virtual reference marks that permit the alignment of all of the mosaic images, each mosaic image being aligned by at least three virtual reference marks using the fewest total number of virtual reference marks. Furthermore, the virtual reference marks are established by selectors from the high coincidence end points that are most evenly dispersed over the mosaic images. The selected end points may further be chosen as having a least uncertainty, and/or being closest to coincidence.

Shown in FIG. 6d, are two end points 244a′ substantially coincident in the x-y plane 247 that are highly suggestive of a via, and a pair of highly coincident end points 244a″. The end points 244a′ (along with other distant end points 244 of the mosaic images 230,232 not in view) are taken to be virtual reference marks.

In step 380 a mosaic image having the least uncertain, and most complete set of the end points that correspond to the virtual reference marks is chosen. The chosen image mosaic forms a frame of reference that is used to define an accurate coordinate space for the end points of the line segment databases. The accurate coordinate space is produced by computing a mean adjustment in both the x and y directions of each of the mosaic images. The mean x and y adjustments for each mosaic image is computed with respect to the end points corresponding to the virtual reference marks. The distances in the x-y plane between the virtual reference marks and the corresponding end points in the mosaic image is minimized to adjust the mosaic image (step 382). The mean x and y adjustments are used when reading the end point coordinates from the records of the line segment database associated with the mosaic image, and are used (in step 384) to refine the alignment of the mosaic images so that the line segments remain in the accurate coordinate space as the mosaic images from which they were derived.

As shown in FIG. 6e, the mosaic image 232 is aligned to mosaic images 230 by effecting an x direction adjustment 248, and a y direction adjustment 249. After adjusting the inter-mosaic alignment, the virtual reference points 244a′ are coincident in the x-y plane 247.

Line segments as extracted in the above-identified manner more accurately define an orientation than end points. End points may be obscured or may not be accurate because of imperfect delayering of the die, imaging defects, etc. The present invention relies on the orientation of the lines to determine points where line segments of different mosaic images would intersect in the x-y plane, if they were extended short distances (i.e. a given fraction of the length of the line segment). In step 386 the end points of the line segments are finalized so that vias that are identified by high coincidences of finalized end points become the end points of connected edges; ‘broken’ lines (line segments of a common line that have been incorrectly separated) are reconnected using a predefined set of rules relating to configurations of the two line segments, etc.

Once the line segments have all been finalized, they are processed to identify connections of the line segments (step 388). The line segments are connected to each other and to vias (step 390), and thereby connected to line segments on other mosaic images to form a virtual representation of the metal lines of the die. These lines are stored in a 3-D model of connections of the area of interest of the die and can be viewed with or without one or more of the mosaic images.

FIG. 6f schematically shows the line segments 246 connected to each other and by a via 251 to line segments 246 in the other mosaic images. The 3-D model of the connections of the die may be viewed as a set of lines as shown in FIG. 6f. In alternative embodiments, the lines are thickened to facilitate viewing and to mask the corresponding lines on the mosaic image.

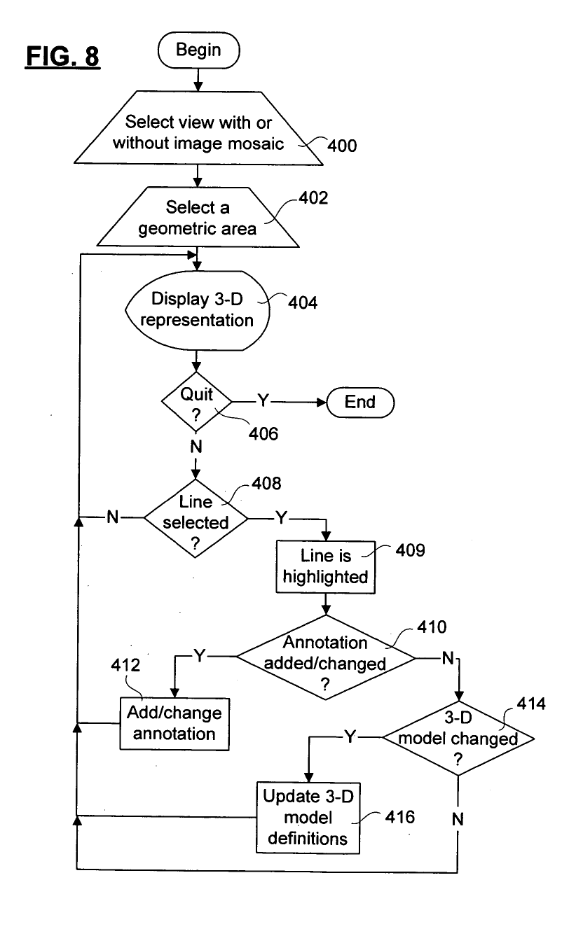

FIG. 8 is a flow chart illustrating principal steps involved in viewing the 3-D model by an operator at a computer workstation, to view the 3-D model, insert annotations associated with the metal lines, etc. In step 400, the operator selects a view that may or may not include the image mosaic(s). The ability to view the 3-D image with or without the image mosaic background is an advantage of the present embodiment of the invention, as it facilitates verification and higher level analysis by the operator. In step 402, the operator selects a geometric area with respect to the 3-D model coordinate space. This may be performed after viewing the entire 3-D model at low resolution, or a schematic representation thereof, or by selecting an area of one or more of the mosaic images, etc. The computer workstation displays the 3-D model of the selected area to the operator (step 404) at an appropriate scale that fits the display surface. If the operator quits the application (step 406), the program ends. Otherwise the operator is preferably provided with options to change the view of the 3-D model and/or the associated parts of mosaic images, by panning and zooming in a manner well known in the art, and may further change the area being viewed by selecting new geometric coordinates.

In step 408 it is determined whether the operator has selected a line. If no line is selected the process returns to step 404. Otherwise, when a line is selected a display of the line becomes highlighted (step 409), and in step 410 the operator may elect to add or change an annotation associated with the selected line (step 410), or may change the connections or length of the line in the 3-D model (step 414), or may return to step 404.

If, the operator elects to add or change an annotation (step 412) the change or addition is made by associating the line in the 3-D model with the new or revised annotation. It is well known in the art to include signal lines, revision data, operator identifiers, and other circuit and model-related annotations to lines of models produced in other ways, and all such annotations may be supported.

If the operator identifies an incorrect connection of line segments, the operator may correct the interconnection manually to change the 3-D model (step 416). The revision of the 3-D model may be effected by selecting end points of the line segments, deleting line segments added to interconnect broken line segments, to identify vias, etc.

The method and apparatus in accordance with the invention provides more accurate alignment of the mosaic images, than has been previously achievable, and permits automated construction of the 3-D model from automatically detected line segments, requiring only minimal operator intervention to verify line segments that are uncertain.

The embodiments of the invention described above are intended to be exemplary only. The scope of the invention is therefore intended to be limited solely by the scope of the appended claims.

1. A method for producing a three-dimensional model of a semiconductor chip from coarsely aligned mosaic images of respective layers of the semiconductor chip, the method comprising:
applying a line detection algorithm to each of the mosaic images to produce a set of line segments identified by x and y coordinates of ends of each line segment with respect to a frame defined by the mosaic image;
establishing virtual reference marks using end points of different mosaic images that are vertically aligned to within an uncertainty of the coarse alignment of the mosaic images;
using the virtual reference marks to adjust x and y coordinates of each of the mosaic images to derive a three dimensional coordinate space; and
processing the end points within the three dimensional coordinate space to define vias, lines and branch lines of the semiconductor chip, interconnected to define the three-dimensional model.

2. The method as claimed in claim 1 wherein applying the line detection algorithm comprises:
applying an edge detector to obtain an edge bitmap defining edge objects;
selecting pixel regions of edge objects that are likely to constitute segments of metal lines, given parameters of the semiconductor chip; and
applying a line tracing algorithm to each edge object to identify and store coordinates of corresponding line segments.

3. The method as claimed in claim 2 wherein applying the line tracing algorithm further comprises storing line segment coordinates in a hierarchical format with branch line segments nested with respect to previously identified line segments.

4. The method as claimed in claim 2 wherein applying an edge detector further comprises applying an algorithm that computes a difference between pixel values of neighboring pixels on opposite sides of a subject pixel to determine that the subject pixel is an edge transition pixel if the difference is above a predefined threshold.

5. The method as claimed in claim 4 wherein applying an edge detector further comprises applying an algorithm derived from at least one of Sobel, Prewitt, Roberts, and Hough transforms.

6. The method as claimed in claim 2 wherein applying the line tracing algorithm further comprises:
applying a line thinning procedure to pixels of the mosaic image bounded by the pixel regions of selected edge objects to produce a thinned line; and
defining the line segments by coordinate positions of the pixels at the ends of line segments, and storing the end point coordinates in a database.

7. The method as claimed in claim 6 wherein applying the line thinning procedure comprises iteratively setting pixel values of boundary pixels to a background pixel value, until the pixels that remain are bounded by background pixel values on two sides.

8. The method as claimed in claim 6 wherein applying the line thinning procedure comprises applying an algorithm derived from at least one of a Zhang Suen skeletonizing algorithm, and a Stentiford skeletonizing algorithm.

9. The method as claimed in claim 6 wherein applying the edge detection algorithm further comprises computing for each line segment a measure of uncertainty that the line segment constitutes a part of a metal line, using properties of the edge object, and properties of the thinned line given the die properties.

10. The method as claimed in claim 9 further comprising requesting an operator to examine the line segments with uncertainty measures above a predefined threshold.

11. The method as claimed in claim 1 wherein establishing virtual reference marks further comprises for each line segment end point on each mosaic image:
counting a number of other mosaic images that have coincident end points in a common projective x-y plane within an uncertainty of the coarse layer alignment;
identifying end points with a high coincidence in the x-y plane; and
selecting from the identified end points the virtual reference marks.

12. The method as claimed in claim 11 further comprising identifying a mosaic image having end points associated with a highest percentage of the virtual reference marks, and aligning each mosaic image to the identified mosaic image by adjusting x and y coordinates of each of the other mosaic images.

13. The method as claimed in claim 1 wherein processing the end points further comprises using predefined rules regarding configuration of the line segments to define lines and branch lines of the semiconductor chip.

14. The method as claimed in claim 1 further comprising displaying the 3-dimensional model to an operator, as a set of lines of predefined thickness.

15. The method as claimed in claim 14 wherein displaying further comprises permitting the user to view any one of the mosaic images alone, the mosaic images with the 3-D model overlayed, and 3-D model alone.

16. The method as claimed in claim 14 wherein displaying the 3-D model to the operator comprises permitting the operator to select any line, to create an annotation for a selected line; and to edit the connectivity of the line segments, and placements of vias.

17. The method as claimed in claim 14 wherein displaying the 3-D model to the operator comprises permitting the operator to select a geometric area, and displaying a part of the 3-D model in the geometric area.

18. An article comprising a computer readable modulated carrier signal and means embedded in the carrier signal for executing the method of any of claims 1-17.

19. An article comprising a computer readable memory storing program instructions and means embedded in the memory for executing the method of any of claims 1-17.

20. An article comprising a computer readable modulated carrier signal for transmitting program instructions for executing the method of any of claims 1-17.
